(19) United States
(12) Patent Application Publication
(10) Pub. No.: US 2015/0014987 A1
(43) Pub. Date: Jan. 15, 2015

(54) MULTIFUNCTION PUMP WITH QUICK CONNECTOR

(71) Applicant: Jianyong Yu, Linhai City (CN)

(72) Inventor: Jianyong Yu, Linhai City (CN)

(21) Appl. No.: 14/042,641

(22) Filed: Sep. 30, 2013

(30) Foreign Application Priority Data
Jul. 11, 2013 (CN) 201320410299.9

(51) Int. Cl. F16L 37/08

(52) U.S. Cl. CPC F16L 37/08
USPC 285/33

(57) ABSTRACT

The present invention discloses a multifunction pump with quick connector, comprising a pump body (1), inlet pipe (2), outlet pipe (3), a piston rod (4), the said piston rod (4) was installed in a cavity of the pump body (1), one end of the pump body (1) provided with the inlet pipe (2) and the other end provided with the outlet pipe (3), characterized in that: a quick connector was installed among the inlet pipe (2), the outlet pipe (3) and a hose, the front end of the said quick connector is linked to a seal ring (6) and is fixed inside of the inlet pipe (2) and the outlet pipe (3). It is able to be fixed automatically after the hose was plugged into the pipes, which is of sealing good, convenient disassembling, safety, stable and high reliability.

### FIELD OF THE INVENTION

The present invention relates to a gas and liquid transportation device, more particularly, it relates to a multifunction pump with quick connector.

### BACKGROUND OF THE INVENTION

In most of the houses, auto part stores or other occasions, people are often require pumping of gasoline, diesel oil, lubricating oil or all types of weak acid, weak alkali liquid; and also change fishbowl's water at home, so the multifunction pumps to convey liquids or gases from one place to another are very common, however, almost existing multifunction pumps are used by inserting structure to connect the pipe with the hose, and then fixed by iron wire or hose clamp or just plugged directly by pressing, by which the gas is prone to be leaked, the hose is loosen easily, and the Sealing Ring of the pump valve core could be stuck in the pump body due to the leak of liquid for ages.

As a result, not only shorten the using lifetime of products, but also affected its quality.

### CONTENTS OF THE INVENTION

The present invention is to solve linking method of the pipe and the hose in the existing multifunction pump, which is prone to leak of gas or liquid, the use of poorly effective and shorter using lifetime. The multifunction pump with quick connector, instead, are used easily, sealed properly, effectively and longer using lifetime.

The present invention was solved the above mentioned technical problems and used in that:

The present invention discloses a multifunction pump with quick connector, comprising a pump body, inlet pipe, outlet pipe, a piston rod, the said piston rod was installed in a cavity of the pump body, one end of the pump body provided with the inlet pipe and the other end provided with the outlet pipe, characterized in that: a quick connector was installed among the inlet pipe, the outlet pipe and a hose, the front end of the said quick connector is linked to a seal ring and is fixed inside of the inlet pipe and the outlet pipe.

The said quick connector was equipped with a Junk Ring, a Gear Ring, a Packing Ring and a tube in sequence, the said Gear Ring was installed into the inside of the Packing Ring and was pressed firmly by the Junk Ring, one end of the said tube was fixed in the Gear Ring, the said the Gear Ring was installed into the inside of the Packing Ring which is comprised by many engaging teeth.

A groove is both in the internal wall of the said inlet pipe and outlet pipe, which is joined the external wall of the Packing Ring together. It is able to be fixed automatically after the hose was plugged into the pipes, which is of sealing good, convenient disassembling, safety, stable and high reliability.

DESCRIPTION OF FIGURES

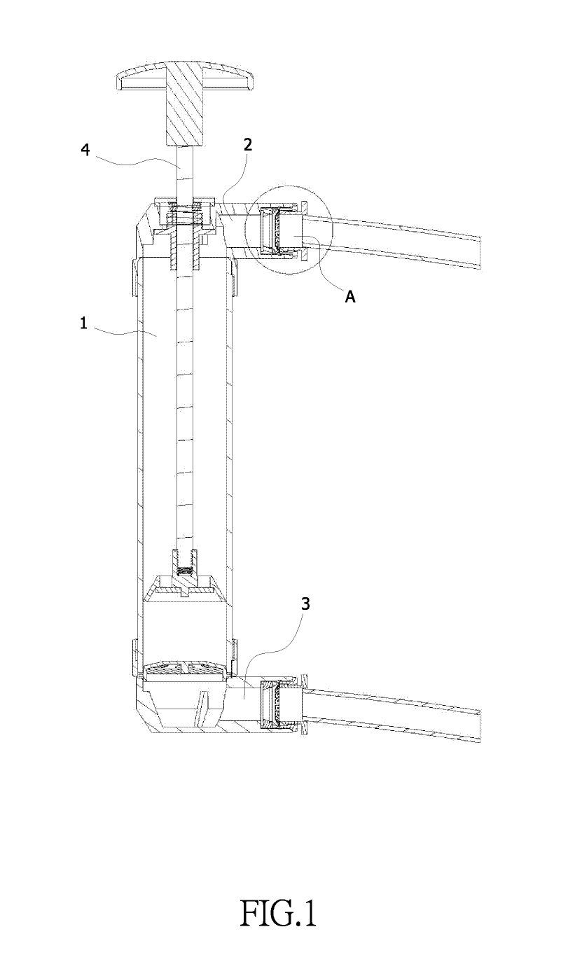

FIG. 1 is a sectional view of a multifunction pump with quick connector according to the present invention.

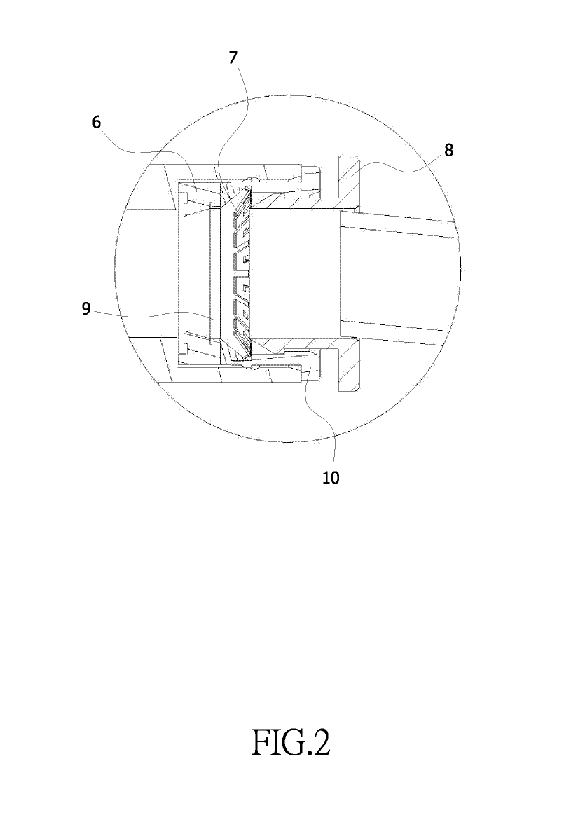

FIG. 2 is an enlarged view of the part A in the multifunction pump with quick connector according to the present invention.

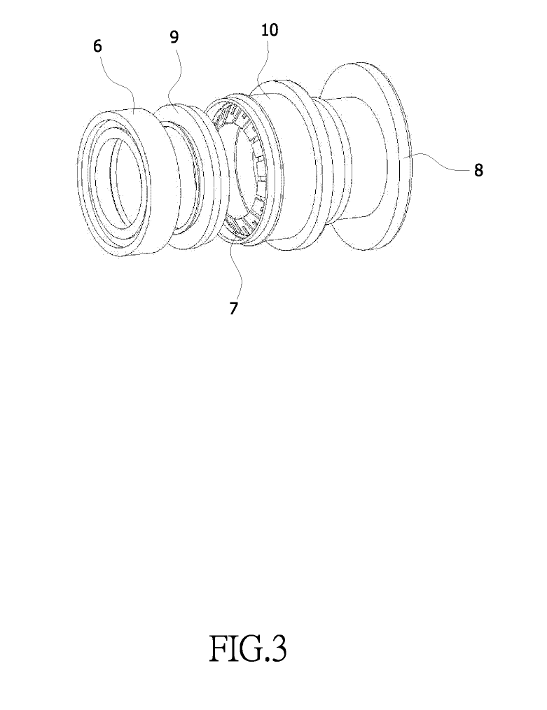

FIG. 3 is an exploded view of the quick connector according to a multifunction pump with quick connector of the present invention.

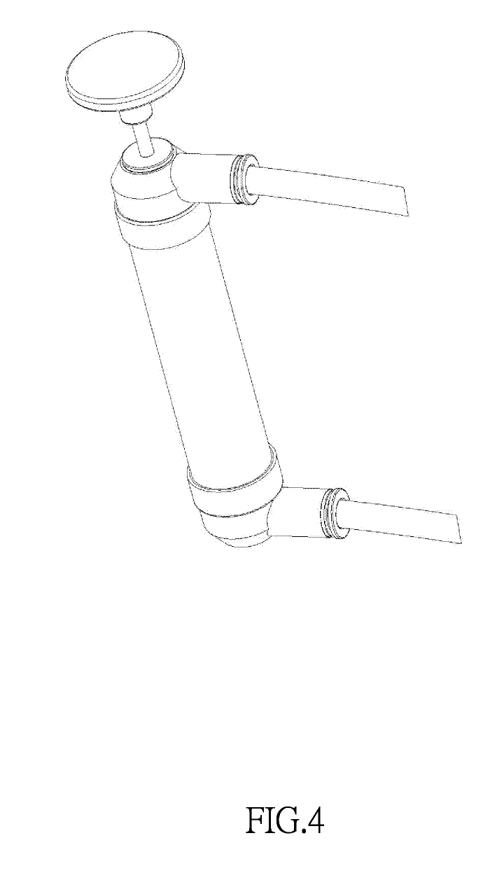

FIG. 4 is a schematic view of a multifunction pump with quick connector according to the present invention.

### DETAILED DESCRIPTION OF THE INVENTION

The preferred embodiments of the present invention are described according appended drawing hereafter

The present invention is disclosed referring to FIG. 1-4. A multifunction pump with quick connector, comprising a pump body (1), inlet pipe (2), outlet pipe (3), a piston rod (4), the said piston rod (4) was installed in a cavity of the pump body (1), one end of the pump body (1) provided with the inlet pipe (2) and the other end provided with the outlet pipe (3), characterized in that: a quick connector was installed among the inlet to pipe (2), the outlet pipe (3) and a hose, the front end of the said quick connector is linked to a seal ring (6) and is fixed inside of the inlet pipe (2) and the outlet pipe (3), In order to install the quick connector into the pipe, which is hard one different from previous soft one, the quick connector in the front end equipped with the seal ring (6) was pressed through the punching machine.

The said quick connector was equipped with a Junk Ring (9), a Gear Ring (7), a Packing Ring (10) and a tube (8) in sequence, the said Gear Ring (7) was installed into the inside of the Packing Ring (10) and was pressed firmly by the Junk Ring (9), one end of the said tube (8) was fixed in the Gear Ring (7), the said the Gear Ring (7) was installed into the inside of the Packing Ring (10) which is comprised by many engaging teeth.

A groove is both in the internal wall of the said inlet pipe (2) and outlet pipe (3), which is joined the external wall of the Packing Ring (10) together.

When in use, the soft pipe was plugged and fixed by the engaging teeth of the Gear Ring (7), which is more firmly with increasing its fixed area. Therefore, the quick connector and soft pipe are not easy to be loosened, When not in use, the soft pipe was pulled out by pushing the tube (8) to compress the Gear Ring (7).

What is claimed is:

1. A multifunction pump with quick connector, comprising a pump body (1), inlet pipe (2), outlet pipe (3), a piston rod (4), the said piston rod (4) was installed in a cavity of the pump body (1), one end of the pump body (1) provided with the inlet pipe (2.) and the other end provided with the outlet pipe (3), characterized in that: a quick connector was installed among the inlet pipe (2), the outlet pipe (3) and a hose, the front end of the said quick connector is linked to a seal ring (6) and is fixed inside of the inlet pipe (2) and the outlet pipe (3).

2. A multifunction pump with quick connector according to claim 1, characterized in that: the said quick connector was equipped with a Junk Ring (9), a Gear Ring (7), a Packing Ring (10) and a tube (8) in sequence, the said Gear Ring (7) was installed into the inside of the Packing Ring (10) and was pressed firmly by the Junk Ring (9), one end of the said tube (8) was fixed in the Gear Ring (7), the said the Gear Ring (7) was installed into the inside of the Packing Ring (10) which is comprised by many engaging teeth.

3. A multifunction pump with quick connector according to claim 1, characterized in that: a groove is both in the internal wall of the said inlet pipe (2) and outlet pipe (3), which is joined the external wall of the Packing Ring (10) together,
